(19) United States
(12) Patent Application Publication
(10) Pub. No.: US 2006/0224713 A1
(43) Pub. Date: Oct. 5, 2006

(54) Distributed computers management program, distributed computers management apparatus and distributed computers management method

(75) Inventor: Yuji Imai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/214,844

(22) Filed: Aug. 31, 2005

(30) Foreign Application Priority Data
Mar. 29, 2005 (JP) 2005-093790

(51) Int. Cl. G06F 15/173

(52) U.S. Cl. 709/223

(57) ABSTRACT

A distributed computers management program, a distributed computers management apparatus and a distributed computers management method can distribute a cryptography process among nodes and safeguard confidential information. The distributed computers management program for causing a computer to execute a distributed computers management method for managing distributed computers having a plurality of nodes comprises a user information storing step that stores user information on the user to be provided with a service by means of the nodes, a program inputting step that inputs a node program to be executed by the nodes, a job determining step that determines the job of the nodes, a job managing step that transmits a corresponding node program to the corresponding nodes and a CA step that issues a server certificate according to the server certificate issuance request received from the nodes and the user information and transmits it to the nodes.

### BACKGROUND OF THE INVENTION

1. Field of the Invention

The present invention relates to a medium that has recorded therein, readably by a computer, a distributed computers management program for causing a computer to execute a distributed computers management method for managing distributed computers having a plurality of nodes, apparatus and a distributed computers management method for safeguarding the services that are provided by a plurality of computers and externally available.

2. Description of the Related Art

Science and technology computation grids and business grids have been developed to provide grid computing services by distributing jobs among a plurality of computers and having them execute the jobs. A science and technology computation grid processes the jobs brought in by a single client by means of a plurality of computers. A business grid processes the requests brought in by a plurality of clients according to the job input from an operator by using a plurality of computers.

In known science and technology computation grids, the operator is authenticated and the utilization of resources is authorized only when jobs are input because the jobs input to each node is quantified when the jobs are input to the GW (gateway) by the operator. For typical grid middleware, authentication information of operators is registered in an external CA (certificate authority) and the authentication information is used only when jobs are input to the GA.

Now, the business grid will be described below by way of two examples.

The configuration of a first known business grid will be described to begin with. FIG. 6 is a schematic block diagram of the known first business grid, illustrating the configuration thereof. The business grid comprises a VO (virtual organization) 101, a plurality of clients 2 and an operator terminal 103. The VO 101 includes a GW 111, a plurality of nodes 112 and at least a shared storage device 13. A job that is brought to nodes 112 from the operator terminal 103 by way of the GW 111 may be a web service program. Then, web services are provided in response to the request from a client 2. The web services are provided by means of a public key cryptography infrastructure in order to maintain the security.

Now, the configuration of the GW 111 will be described below. FIG. 7 is a schematic block diagram of the known GW, illustrating the configuration thereof. The GW 111 includes a GSI (grid security infrastructure) section 121, a BRK (broker) section 122 and a JM (job managing) section 123.

In a business grid, requests for web services may be brought in by a plurality of clients 2 at any time to the VO 101. Therefore, the resources that can be assigned to a job will increase or decrease depending on the number of requests. In order to make the business grid adaptable to such a situation, it is necessary to repeatedly input and terminate a job on a node by node basis. Then, a person who brings in the job has to be authenticated at the time of the input. To make such frequent authentications possible in the known first business grid, ZARs (zero administration archives) that contain programs and initial data are made to include confidential information such as information on server certificates and secret keys at the operator terminal 103 and distributed to the plurality of nodes 112 by way of the GW111. Therefore, the nodes 112 have to share the same confidential information and, at the same time, keep it. Each node 112 performs cryptography processes such as encryption processes and decryption processes, using the delivered confidential information.

Now, the operation of the known first business grid will be described below. FIG. 8 illustrates the sequence of operation of the known first business grid. Firstly, the operator terminal 103 prepares a ZAR (T111). A ZAR is a package that contains a web service program, initial data and a server certificate. Additionally, the operator terminal 103 obtains the server certificate from the external CA in advance. Then, the operator terminal 103 puts a signature on the ZAR, using the secret key, for the purpose of prevention of falsifications (T12). Thereafter, the operator terminal 103 inputs the ZAR to the GW 111 (T13).

Subsequently, the GSI section 121 of the GW 111 confirms that the ZAR is input by the right operator and is not falsified by checking the signature on the received ZAR (T21). The GW 111 proceeds to the following steps of the process only when the outcome of the signature checking is positive. Then, the BRK section 122 of the GW 111 selects the node 112 to be used for the web service (T122). Thereafter, the JM section 123 of the GW 111 transmits the ZAR to the node selected by the BRK section 122 (T23).

Then, the node 112 develops the received ZAR and acquires the web service program, the initial data and the server certificate (T131). Thereafter, the node 112 provides the web service, using the web service program, the initial data and the server certificate (T151) and ends the sequence.

Now, a known second business grid that is adapted to intensively process codes by using confidential information will be described below. Firstly, the configuration of the known second business grid will be described. FIG. 9 is a schematic block diagram of the known second business grid, illustrating the configuration thereof. In FIG. 9, the reference symbols same as those of FIG. 6 respectively denote the same or equivalent components and hence will not be described here any further. By comparing FIG. 9 with FIG. 6, it will be seen that the known second business grid comprises a VO 201 and an operator terminal 203 instead of the VO 101 and the operator terminal 103 of the first business grid. It will also be seen by comparing the VO 201 with the VO 101, the former includes nodes 212 instead of the nodes 112 of the VO 101 and additionally an SSL accelerator 214.

A client 2 communicates with one of the nodes 212 to transmit a web service request or the like using TLS (transport layer security)/SSL (secure socket layer) and/or SOAP (simple object access protocol). The SSL accelerator 214 is interposed between the client 2 and the node 212. The SSL accelerator 214 acquires a server certificate from an external CA in advance and executes a cryptography process for the communication with the client 2, using the server certificate. In other words, the node 212 does not need to execute any cryptography process and keep confidential information. The SSL accelerator 214 may distribute a load among a plurality of nodes 212.

Now, the operation of the known second business grid will be described below. FIG. 10 illustrates the sequence of operation of the known second business grid. In FIG. 10, the reference symbols same as those of FIG. 8 respectively denote the same or equivalent steps and hence will not be described here any further. By comparing FIG. 10 with FIG. 8, it will be seen that the sequence of operation of the known second business grid includes Step T211 instead of Step T111 of FIG. 8. The operator terminal 203 prepares a ZAR that is a package containing a web service program and initial data in this step (T211). It will also be seen that the sequence of operation of the known second business grid includes Step T231 instead of Step T131 of FIG. 8. In this step, the node 212 develops the received ZAR and acquires the web service program and the initial data (T231). Furthermore, the sequence of operation of the known second business grid includes Step T251 instead of Step T151 of FIG. 8. In this step, the node 212 provides the web service, using the web service program and the initial data (T251).

The conventional art relevant to the present invention includes Patent Document 1 listed below. The patent document 1 describes an accounting management method and an accounting management apparatus for grid computing that can provide a scheme by which a grid manager can correctly charge for the input jobs.

[Patent Document 1]

Japanese Patent Application Laid-Open Publication No. 2004-272669

However, since the nodes 112 of the above-described known first business grid transmit, receive, share and keep confidential information, the business grid involves by a high risk of leakage of confidential information. Additionally, since confidential information is shared, the VO 101 becomes entirely unusable once the confidential information leaks.

Since the SSL accelerator 214 of the above-described known second business grid intensively processes codes, it is required to have a high processing potential and use hardware for the processes. In other words, the business grid is costly. Additionally, WS (web services)—Security and SAML (security assertion markup language) that are highly convenient for web services are not suited for hardware processes like those of the SSL accelerator 214 because they are adapted to process ciphers and put a signature on part of XML (extensible markup language).

### SUMMARY OF THE INVENTION

In view of the above-identified problems, it is therefore an object of the present invention to provide a medium that has recorded therein, readably by a computer, a distributed computers management program for causing a computer to execute a distributed computers management method for managing distributed computers having a plurality of nodes, a distributed computers management apparatus and a distributed computers management method for distributing a cipher process among nodes and safeguarding confidential information.

In an aspect of the present invention, the above object is achieved by providing a medium that has recorded therein, readably by a computer, a distributed computers management program for causing a computer to execute a distributed computers management method for managing distributed computers having a plurality of nodes, a user information storing step that stores user information on the user to be provided with a service by means of the nodes; a program inputting step that inputs a node program to be executed by the nodes; a job determining step that determines the job of the nodes; a job managing step that transmits a corresponding node program to the corresponding nodes according to the job; and a CA step that issues a server certificate according to the server certificate issuance request received from the nodes and the user information and transmits it to the nodes.

In a distributed computers management program according to the invention, the service is a web service.

In a distributed computers management program according to the invention, the server certificate is a certificate prepared by adding information on the nodes to the certificate in the CA step acquired from an external CA.

In a distributed computers management program according to the invention, the job determining step further determines the period of the job according to the user information.

In a distributed computers management program according to the invention, the server certificate contains an effective period of the server certificate and the effective period agrees with the period of the job.

In a distributed computers management program according to the invention, the server certificate issuance request contains public keys of the nodes.

In a distributed computers management program according to the invention, the program inputting step externally receives a node program carrying a signature thereon and checks if it is a proper node program or not according to the signature.

In another aspect of the present invention, there is provided a distributed computers management apparatus for managing distributed computers having a plurality of nodes, the apparatus comprising: a user information storing section that stores user information on the user to be provided with a service by means of the nodes; a program inputting section that inputs a node program to be executed by the nodes; a job determining section that determines the job of the nodes; a job managing section that transmits a corresponding node program to the corresponding nodes according to the job; and a CA section that issues a server certificate according to the server certificate issuance request received from the nodes and the user information and transmits it to the nodes.

In a distributed computers management apparatus according to the invention, the service is a web service.

In a distributed computers management apparatus according to the invention, the server certificate is a certificate prepared by adding information on the nodes to the certificate of the CA section acquired from an external CA.

In a distributed computers management apparatus according to the invention, the job determining section further determines the period of the job according to the user information.

In a distributed computers management apparatus according to the invention, the server certificate contains an effective period of the server certificate and the effective period agrees with the period of the job.

In a distributed computers management apparatus according to the invention, the server certificate issuance request contains public keys of the nodes.

In a distributed computers management apparatus according to the invention, the program inputting section externally receives a node program carrying a signature thereon and checks if it is a proper node program or not according to the signature.

In still another aspect of the present invention, there is provided a distributed computers management method for managing a distributed computers management apparatus and distributed computers having a plurality of nodes, the method comprising: a user information storing step that stores user information on the user to be provided with a service by means of the nodes in the distributed computers management apparatus; a program inputting step that inputs a node program to be executed by the nodes in the distributed computers management apparatus; a job determining step that determines the job of the nodes in the distributed computers management apparatus; a job managing step that transmits a corresponding node program to the corresponding nodes according to the job in the distributed computers management apparatus; and a CA step that issues a server certificate according to the server certificate issuance request received from the nodes and the user information and transmits it to the nodes in the distributed computers management apparatus.

A distributed computers management method may further comprise: a server certificate issuance request step that generates a secret key and a public key for receiving the node program from the distributed computers management apparatus at the nodes and transmits a server certificate issuance request containing the public key to the distributed computers management apparatus between the job managing step and the CA step; and a service providing step that receives the server certificate from the distributed computers management apparatus at the nodes and provides the service, using the node program and the server certificate after the CA step.

While the known first business grid makes communications on ZARs containing confidential information, the present invention provides a higher degree of security because no confidential information goes out from the nodes. While the known second business grid needs an SSL accelerator, the present invention does not need cryptography process that requires the use of an SSL accelerator because each of the nodes executes cryptography processes and, according to the invention, it is possible to make communications using WS-Security, SAML and the like that are difficult for an SSL accelerator.

### BRIEF DESCRIPTION OF THE DRAWINGS

FIG. 1 is a schematic block diagram of a business grid to which the present invention is applicable, illustrating the configuration thereof;

FIG. 2 is a schematic block diagram of a GW to which the present invention is applicable, illustrating the configuration thereof;

FIG. 3 is a schematic block diagram of one of the nodes to which the present invention is applicable, illustrating the configuration thereof;

FIG. 4 is a sequence diagram of the operation of a business grid to which the present invention is applicable;

FIG. 5 is a schematic illustration of a server certificate to which the present invention is applicable;

FIG. 6 is a schematic block diagram of a known first business grid, illustrating the configuration thereof;

FIG. 7 is a schematic block diagram of a known GW;

FIG. 8 is a sequence diagram of the operation of the known first business grid;

FIG. 9 is a schematic block diagram of a known second business grid, illustrating the configuration thereof; and

FIG. 10 is a sequence diagram of the operation of the known second business grid.

### DETAILED DESCRIPTION OF THE PREFERRED EMBODIMENTS

Now, the present invention will be described by referring to the accompanying drawings that illustrate a preferred embodiment of the invention.

Firstly, a business grid to which the present invention is applicable will be described below.

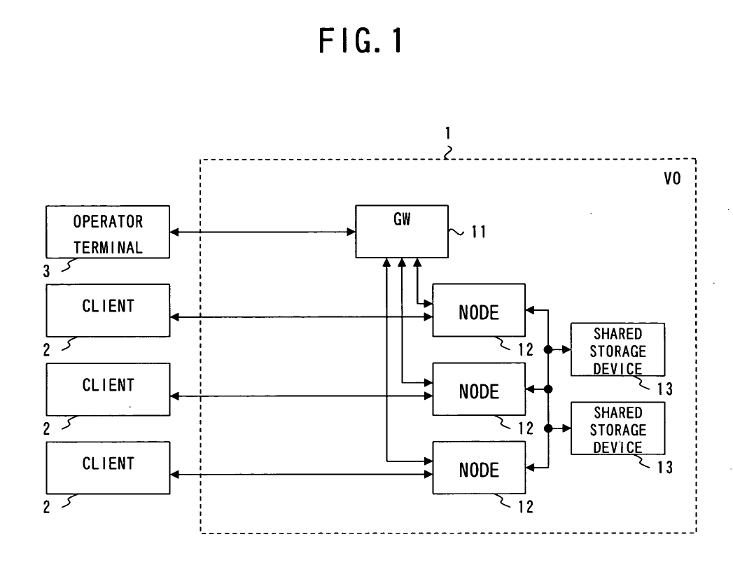

FIG. 1 is a schematic block diagram of a business grid to which the present invention is applicable, illustrating the configuration thereof.

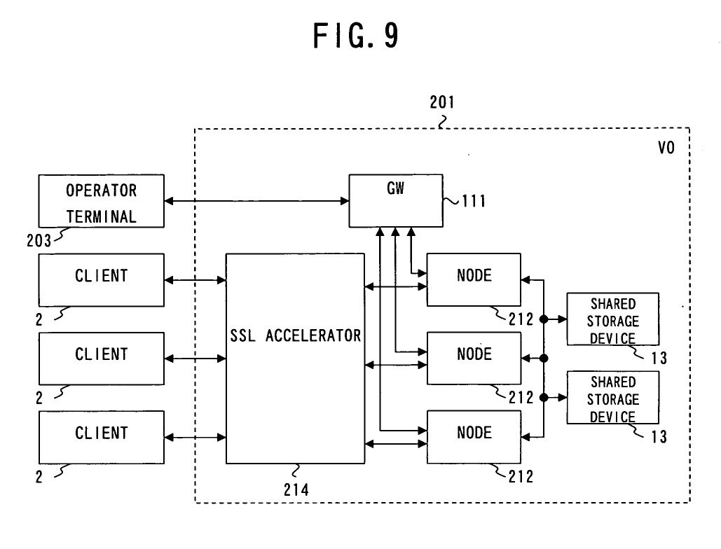

In FIG. 1, the components same as or similar to those of FIG. 9 are denoted respectively by the same reference symbols and will not be described here any further. By comparing FIG. 1 and FIG. 9, it will be seen that the business grid of FIG. 1 comprises a VO 1 instead of the VO 201 of FIG. 9. By comparing the VO 1 with the VO 201, it will be seen that it includes a GW 11 and a node 12 instead of the GW 111 and the node 212 of VO 201 and does not need the SSL accelerator 214. Like the known business grid, the job input to the nodes 12 from the operator terminal 3 by way of the GW 11 is typically a web service program for providing a web service in response to the request of one of the clients 2.

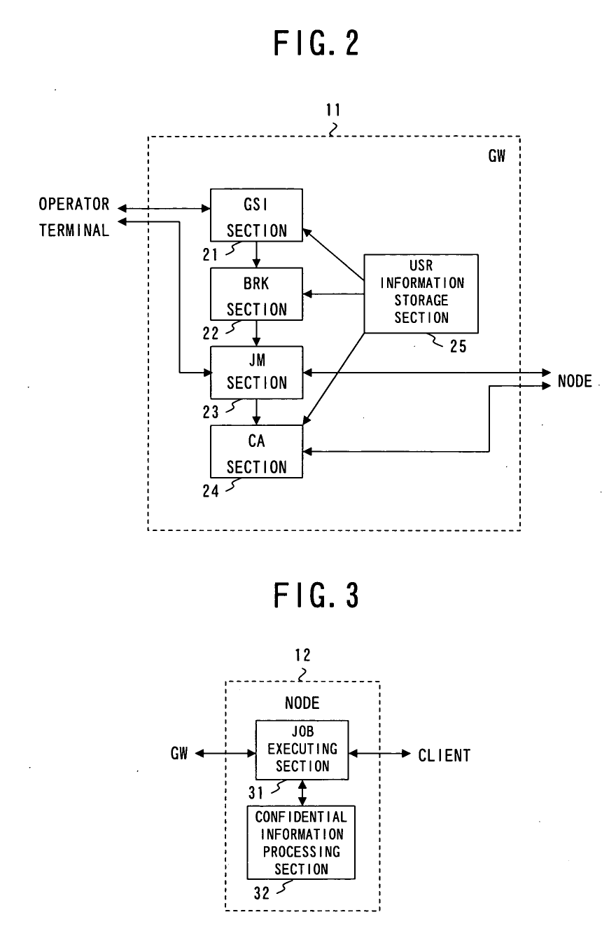

Now, the configuration of the GW 11 will be described below. FIG. 2 is a schematic block diagram of the GW to which the present invention is applicable. Referring to FIG. 2, the GW 11 includes a GSI section 21, a BRK section 22, a JM section 23, a CA section 24 and a user information storage section 25. The user refers to the user who provides web services by renting the server built in the VO 1, and the user information storage section 25 stores in advance the organization name, the section name, the URL (uniform resource locators), a period of the lease of the server to the user and other user information.

Now, the configuration of the nodes 12 will be described below. FIG. 3 is a schematic block diagram of one of the nodes to which the present invention is applicable, illustrating the configuration thereof. The node 12 includes a job executing section 31 and a confidential information processing section 32. The confidential information processing section 32 generates and holds a pair of a secret key and a public key and executes cryptography processes such as encryptions and decryptions. The confidential information processing section 32 is typically realized by an anti-tampering code card. An anti-tampering code card is protected by hardware and hence can safeguard confidential information. The confidential information processing section 32 may be realized by software. The security level of the node 12 is enhanced because confidential information is held by the confidential information processing section 32 so as not to go out from the node 12. Additionally, it is no longer necessary to use an SSL accelerator for cryptography processes and it is possible to do communications, using WS-Security and SAML, that are difficult for the SSL accelerator to do because the confidential information processing section 32 is adapted to execute cryptography processes. The business grid may comprise a device for distributing loads among the nodes that may operate like an SSL accelerator.

Now, the operation of the business grid to which the present invention is applied will be described below.

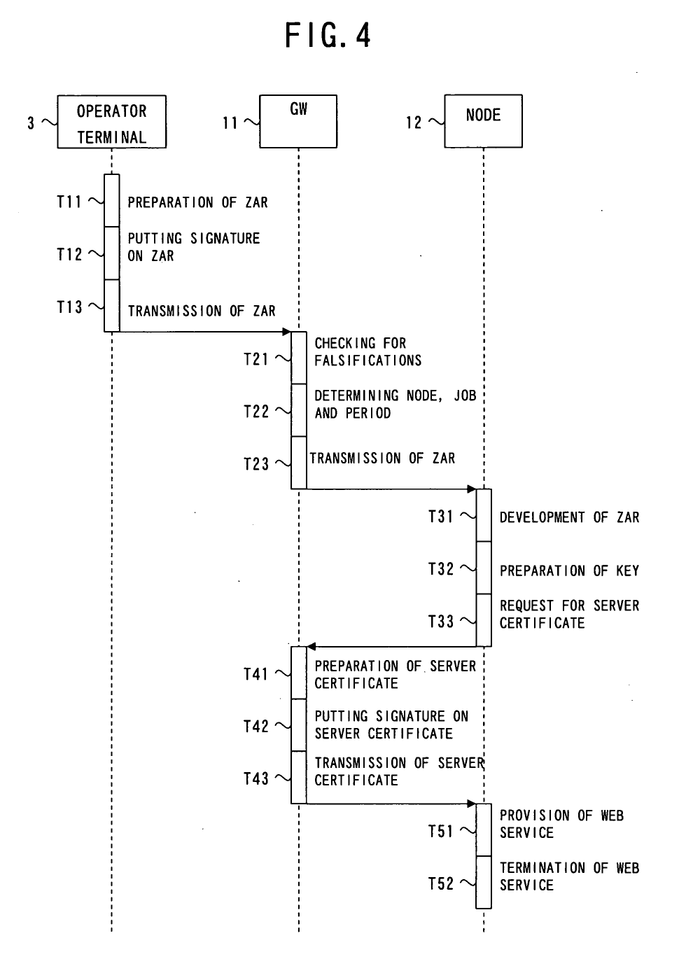

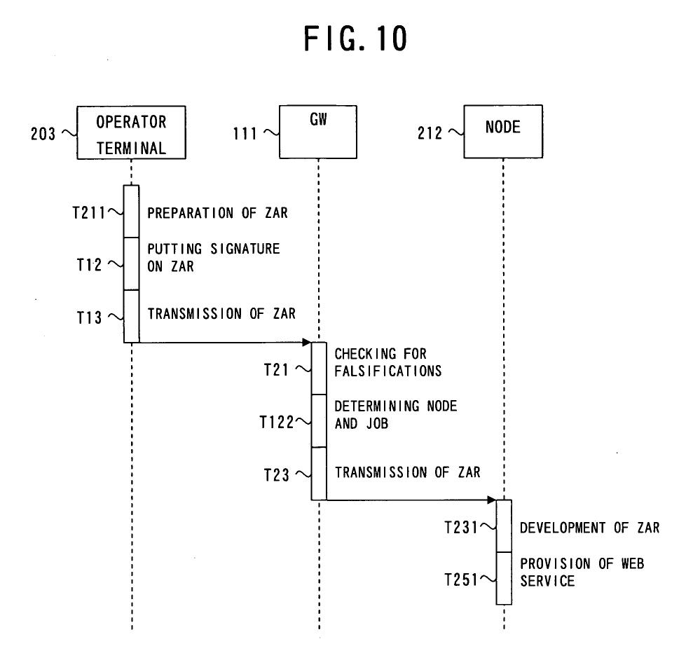

FIG. 4 is a sequence diagram of the operation of the business grid to which the present invention is applied. In FIG. 4, the reference symbols same as those of FIG. 10 respectively denote the same or equivalent steps and hence will not be described here any further. Firstly, the operator terminal 3 prepares a ZAR (T11). A ZAR is a package that contains a web service program and initial data but, unlike known ZARs, does not contain any server certificate. Then, the operator terminal 3 puts a signature on the ZAR, using the secret key of the operator terminal 3, for the purpose of prevention of falsifications (T12). Thereafter, the operator terminal 3 inputs the ZAR to the GW 11 (T13).

Subsequently, the GSI section 21 of the GW 11 confirms that the ZAR is input by the right operator and is not falsified (T21) by checking the signature on the received ZAR. Then, the BRK section 22 of the GW 11 selects a node 12, a job and a period by referring to the user information storage section 25 (T22). Thereafter, the JM section 23 of the GW 11 transmits the ZAR to the node selected by the BRK section 22 (T23).

Then, the program executing section 31 of the node 12 develops the received ZAR and acquires the web service program and the initial data (T31). Thereafter, the confidential information processing section 32 of the node 12 prepares a pair of a secret key and a public key (T32). Subsequently, the program executing section 31 of the node 12 transmits a request for a server certificate to the GW11 (T33).

Then, the CA section 24 of the GW 11 prepares server attributes to correspond to the node 12 to which the JM section 23 inputs the job by referring to the user information storage section 25 and also prepares a server certificate by adding the server attributes to the server certificate acquired from the external CA (T41). Note that the server attributes include the registration information of the above-described user. Thereafter, the CA section 24 of the GW 11 puts a signature to the server certificate (T42). Subsequently, the CA section 24 of the GW 11 transmits the server certificate to the node 12 that made the request (T43).

Then, the node 12 provides the web service, using the web service program, the initial data and the server certificate (T51). Thereafter, the node 12 terminates the web service (T52) to complete the sequence. Note that the provision and the termination of the web service of the node 12 take place according to an effective period of the server certificate, which will be described hereinafter, an instruction from the JM section 23, and the like.

Now, the server certificate that the CA section 24 issues to the node 12 will be described below.

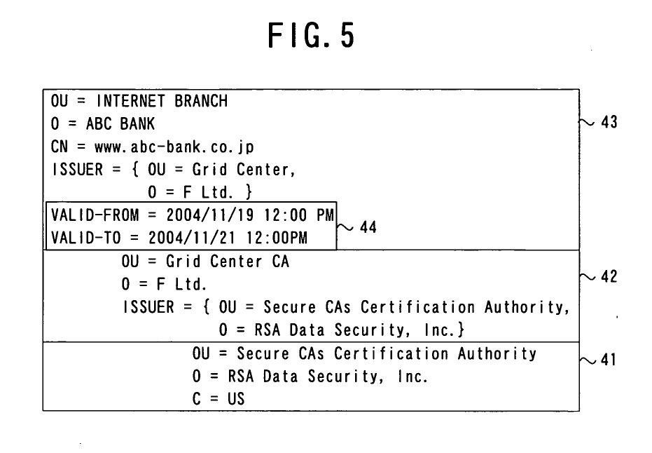

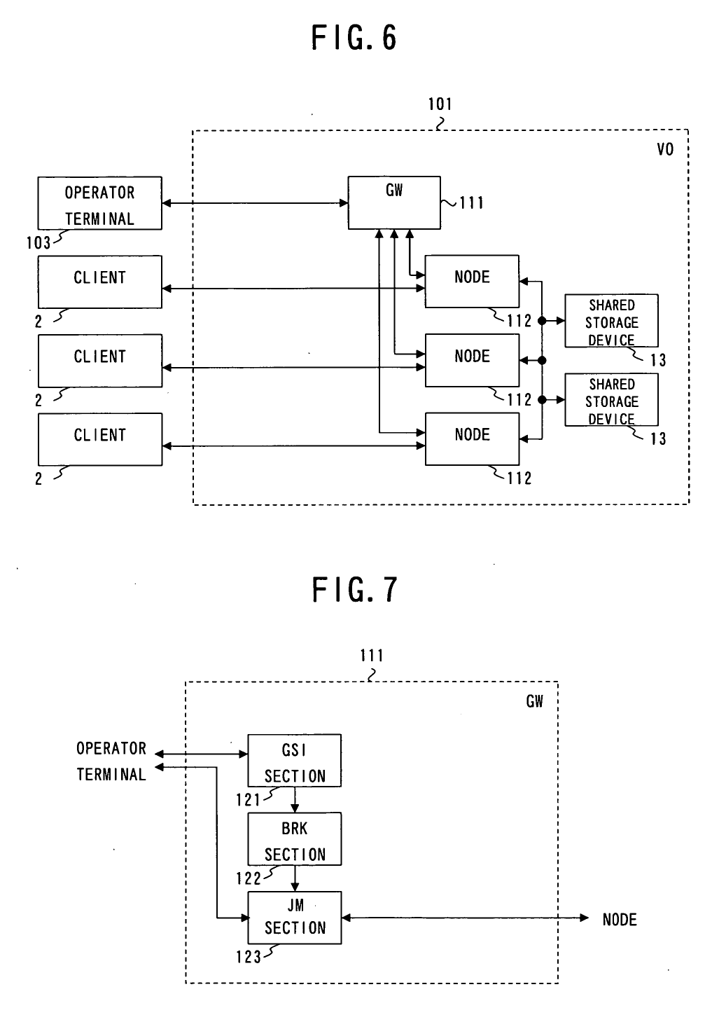

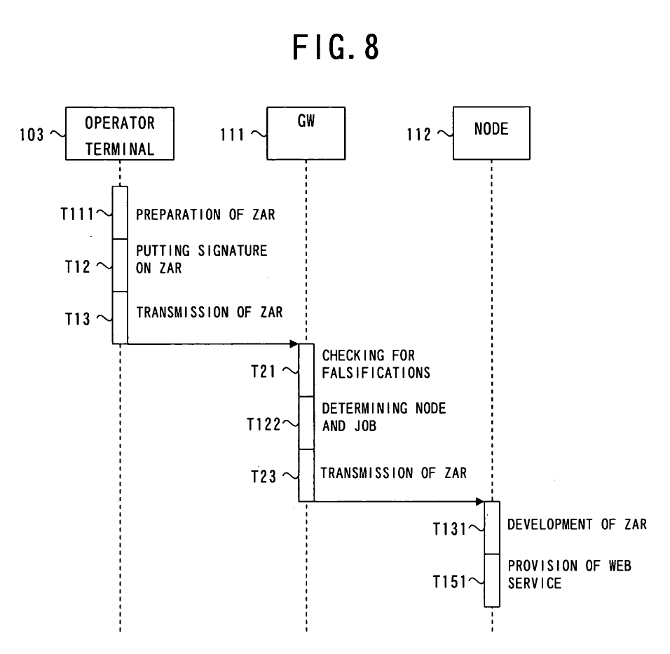

FIG. 5 is a schematic illustration of a server certificate to which the present invention is applicable. In FIG. 5, C represents country and O represents organization, whereas OU represents organization unit and CN represents canonical name, which may typically be URL. The server certificate is prepared in connection with a certificate issued from a different CA and a route certifying section 41, a grid certifying section 42 and a server certifying section 43 are linked in it. The route certifying section 41 is a section that certifies a route CA and is delivered in advance in a state buried in a browser or the like. The grid certifying section 42 is a section that certifies the CA section 24. It is a part prepared in advance by the route CA. The server certifying section 43 is a section that certifies the corresponding node 12. It is a part prepared by the CA section 24 in Step T41. An effective period 44 in the server certifying section 43 is prepared so as to correspond to the period of the lease of the server to the user that is determined by the BRK22. The node 12 executes the job for the effective period 44 and erases the confidential information after the end of the job.

The effective period may not be contained in the server certificate. For ending the job of the node 12, it may so arranged that the node 12 automatically end the job or that the job is terminated by the command to the JM section 23 and the server certificate of the node 12 of the terminated job is added to the CRL (certificate revocation list) of the CA section 24 so as to be revoked.

Additionally, it is possible to provide a program for causing the computer of the distributed computers management apparatus to execute the above-listed steps as distributed computers management program. The above-described program can be executed by the computer of the distributed computers management apparatus by storing the program in the recording mediums that are readable to the computer. Recording mediums that are readable to the computer include internal storage devices that can be mounted in the computer such as ROMs and RAMs, portable storage mediums such as CD-ROMs, flexible disks, DVDs, magneto optical disks and IC cards, data bases holding computer programs, other computers, data bases of such computers and transmission mediums on communication lines.

Distributed computers correspond to the VO of the above-described embodiment. A distributed computers management apparatus corresponds to the GW of the above-described embodiment. A program input section corresponds to the GSI section of the above-described embodiment. A job determining section corresponds to the BRK section of the above-described embodiment. A job managing section corresponds to the JM section of the above-described embodiment. A program inputting step corresponds to the processing step T21 of the above-described embodiment. A job determining step corresponds to the processing step T22 of the above described embodiment. A job managing step corresponds to the processing step T23 of the above-described embodiment. A server certificate issuance requesting step corresponds to the processing steps T31, T32 and T33 of the above-described embodiment. A CA step corresponds to the processing steps T41, T42 and T43 of the above-described embodiment. A service providing step corresponds to the processing steps T51, T52 of the above described embodiment.

What is claimed is:

1. The medium that has recorded therein, readably by a computer, a distributed computers management program for causing a computer to execute a distributed computers management method for managing distributed computers having a plurality of nodes, the program comprising:
a user information storing step that stores user information on the user to be provided with a service by means of the nodes;
a program inputting step that inputs a node program to be executed by the nodes;
a job determining step that determines the job of the nodes;
a job managing step that transmits a corresponding node program to the corresponding nodes according to the job; and
a CA step that issues a server certificate according to the server certificate issuance request received from the nodes and the user information and transmits it to the nodes.

2. The medium that has recorded therein a distributed computers management program according to claim 1, wherein the service is a web service.

3. The medium that has recorded therein a distributed computers management program according to claim 1, wherein the server certificate is a certificate prepared by adding information on the nodes to the certificate in the CA step acquired from an external CA.

4. The medium that has recorded therein a distributed computers management program according to claim 1, wherein the job determining step further determines the period of the job according to the user information.

5. The medium that has recorded therein a distributed computers management program according to claim 4, wherein the server certificate contains an effective period of the server certificate and the effective period agrees with the period of the job.

6. The medium that has recorded therein a distributed computers management program according to claim 1, wherein the server certificate issuance request contains public keys of the nodes.

7. The medium that has recorded therein a distributed computers management program according to claim 1, wherein the program inputting step externally receives a node program carrying a signature thereon and checks if it is a proper node program or not according to the signature.

8. A distributed computers management apparatus for managing distributed computers having a plurality of nodes, the apparatus comprising:
a user information storing section that stores user information on the user to be provided with a service by means of the nodes;
a program inputting section that inputs a node program to be executed by the nodes;
a job determining section that determines the job of the nodes;
a job managing section that transmits a corresponding node program to the corresponding nodes according to the job; and
a CA section that issues a server certificate according to the server certificate issuance request received from the nodes and the user information and transmits it to the nodes.

9. The apparatus according to claim 8, wherein the service is a web service.

10. The apparatus according to claim 8, wherein the server certificate is a certificate prepared by adding information on the nodes to the certificate of the CA section acquired from an external CA.

11. The apparatus according to claim 8, wherein the job determining section further determines the period of the job according to the user information.

12. The apparatus according to claim 11, wherein the server certificate contains an effective period of the server certificate and the effective period agrees with the period of the job.

13. The apparatus according to claim 8, wherein the server certificate issuance request contains public keys of the nodes.

14. The apparatus according to claim 8, wherein the program inputting section externally receives a node program carrying a signature thereon and checks if it is a proper node program or not according to the signature.

15. A distributed computers management method for managing a distributed computers management apparatus and distributed computers having a plurality of nodes, the method comprising:
a user information storing step that stores user information on the user to be provided with a service by means of the nodes in the distributed computers management apparatus;
a program inputting step that inputs a node program to be executed by the nodes in the distributed computers management apparatus;
a job determining step that determines the job of the nodes in the distributed computers management apparatus;
a job managing step that transmits a corresponding node program to the corresponding nodes according to the job in the distributed computers management apparatus; and
a CA step that issues a server certificate according to the server certificate issuance request received from the nodes and the user information and transmits it to the nodes in the distributed computers management apparatus.

16. The method according to claim 15, wherein the service is a web service.

17. The method according to claim 15, wherein the server certificate is a certificate prepared by adding information on the nodes to the certificate in the CA step acquired from an external CA.

18. The method according to claim 15, wherein the job determining step further determines the period of the job according to the user information.

19. The method according to claim 18, wherein the server certificate contains an effective period of the server certificate and the effective period agrees with the period of the job.

20. The method according to claim 15, further comprising:
a server certificate issuance request step that generates a secret key and a public key for receiving the node program from the distributed computers management apparatus at the nodes and transmits a server certificate issuance request containing the public key to the distributed computers management apparatus between the job managing step and the CA step; and
a service providing step that receives the server certificate from the distributed computers management apparatus at the nodes and provides the service, using the node program and the server certificate after the CA step.
